(19) United States
(12) Patent Application Publication
(10) Pub. No.: US 2014/0099412 A1
(43) Pub. Date: Apr. 10, 2014

(54) PROCESS FOR PREPARING AND FORMULATION FOR AERATED BAKED FOOD PRODUCTS AND CHOCOLATE PRODUCTS

(71) Applicant: THE HERSHEY COMPANY, Hershey, PA (US)

(72) Inventors: Philip C. Ward, Palmyra, PA (US); Julia Emsing Mann, Annville, PA (US); Craig N. Rank, Harrisburg, PA (US); Jeremy D. Haag, Lebanon, PA (US)

(21) Appl. No.: 14/095,258

(22) Filed: Dec. 3, 2013

(30) Foreign Application Priority Data
Jun. 4, 2012 (US) PCT/US2012/040763

(51) Int. Cl. A23G 1/52

(52) U.S. Cl. CPC A23G 1/52
USPC 426/250; 426/572; 426/568

(57) ABSTRACT

The invention includes a process for preparing an aerated food product employing a refined chocolate crumb blend and an aeration agent. The methods also include a process for refining chocolate liquor and cocoa powder into a refined crumb blend, and the use this refined crumb blend in producing novel and advantageous food products and ingredients. One advantageous product of the invention is an aerated, chocolate meringue-type product made with chocolate liquor and containing cocoa butter or fat.

This application claims priority to U.S. provisional application 61/493,263, filed Jun. 3, 2011, and to PCT application US2012/040763, filed Jun. 4, 2012, the entire contents of both are hereby incorporated by reference.

### FIELD OF THE INVENTION

In one aspect the invention relates to a process for preparing an aerated chocolate food product employing a refined chocolate crumb blend and an aeration agent. In another aspect, the invention relates to methods for refining chocolate liquor into a refined crumb blend, and the use this refined crumb blend in producing novel and advantageous food products and ingredients. One advantageous product of the invention is an aerated, chocolate meringue-type product made with chocolate liquor containing cocoa butter or fat. Unlike similar fat-containing products of this type, the products of the invention hold their shape and texture despite the relatively high levels of fat, and they can be baked and formed into a final chocolate product that contains up to 15% chocolate liquor, one of the requirements for standard of identity chocolate under US FDA requirements.

### RELEVANCE OF THE INVENTION AND DESCRIPTION OF RELATED ART

Food and confectionery products and ingredients with sufficient levels of fat or having a fat-continuous phase, such as chocolate, butter, margarine, peanut butter, chocolate spread and the like, are generally unaerated products. Aeration can be desirable for variety of purposes, including modifying texture, softness or spreadability, and changing the visual appearance of the product. When it is an aerated product, chocolate is usually aerated by using pressurized conditions and gas, for example carbon dioxide, which is mixed into a molten chocolate. The pressure is then released and the gas bubbles expand within the chocolate, forming an aerated product when cooled. Alternatively, vacuum-dependent steps can be used in a similar manner, also introducing bubbles during a phase of production.

A well-known example of an aerated chocolate is the Aero™ bar. The production method is complex, however, and requires one or more chilled or frozen depositions and setting periods. Similarly, the firm-textured Volcano™ chocolate product requires pressurized production steps.

Aerating using whipping agents is an alternative to pressurization. In its simplest form, a traditional chocolate mousse is prepared by melting chocolate and folding it into whipped egg whites. No pressurization steps or equipment are required. One can include low levels of fat, in the form of butter, cream or egg yolks. However, the chocolate mousse must be kept cooled to maintain its form. Heating or baking causes the mousse to collapse and lose its shape. Generally, however, the water-continuous products, such as mousse or ice cream, are much easier to aerate than fat-continuous food products by simply whipping in the presence of an emulsifier, although they require storage and serving at low temperatures.

Cocoa ingredients containing significant levels of cocoa butter present real problems in producing a stable aerated product that does not require refrigeration. Chocolate liquor is generally a low-melting solid that contains approximately 53-56% by weight cocoa butter (fat). The high levels of fat make it difficult or impossible to use in most food production techniques, and that is especially the case when considering aerated products. Another consequence of the fat levels in chocolate liquor is its inability to be easily dispersed in water formulations. This effectively prohibits its use in dry mixes and other products where water is a major component. Furthermore, and also because of the fat content, producing a powder-like form of chocolate liquor that can be easily used as an ingredient for food products is difficult. Cocoa powder, which is pressed from chocolate liquor in a process that removes most of the cocoa butter, is thus the form of cocoa used in chocolate food products and particularly in aerated products.

There are significant taste differences between chocolate liquor and cocoa powder, however, and most consumers prefer the taste profile of a chocolate-liquor based product as compared to cocoa powder. Thus, if products and ingredients were available that utilized chocolate liquor as an ingredient for an aerated product, these product would have an advantageous taste profile compared to others using only cocoa powder.

As described more fully below, the invention here involves in one aspect the production of a refined crumb blend of chocolate liquor. This refined crumb blend can be advantageously used in a number of food production processes, including processes to produce an aerated, baked chocolate meringue.

### BRIEF SUMMARY OF THE INVENTION

The object of the invention, in one aspect, is a method of manufacturing a fat-containing, yet light, aerated, and crispy meringue-type confection. The final product can contain concentrated levels of fat-containing ingredients, such as a milk powder or chocolate liquor. A fat-containing, baked meringue-type product is not currently available and the manufacture of such a product has been hampered by the inability to maintain a foam matrix in the presence of high levels of fat. As one of ordinary skill in the art understands, using high levels of fat or certain fat-containing ingredients, or even directly adding a fat, especially liquid fats and oils, causes an eventual if not immediate collapse of the foam matrix.

In contrast to the invention, the typical baked meringue products, such as cookies, are made with high levels of sugar and whipped egg whites and contain very little to no fat content. The present invention teaches a method that allows addition of fat and fat-containing ingredients to the recipe by applying a modification of a refining procedure similar to that used in chocolate making. The refining method produces a refined powder, or crumb blend, with a desired particle size range. In addition, an improved foam matrix to that of egg albumen alone can be formulated to help maintain aeration once the refined powder is added. Application of the invention allows for the production of products that have excellent flavor and a crisp texture. Advantageously, under U.S. FDA guidelines or other guidelines for the SOI of chocolate, properly formulated aerated products of the invention can still be labeled as , “reduced fat chocolate”, “reduced fat milk chocolate”, or “made with chocolate” as examples. Other options, not tied to a specific SOI labeling, are also possible.

In a particular aspect, the invention includes methods for producing a baked chocolate meringue food product, which can be a final product or an ingredient in a food product. In general, the methods encompasses the following steps: a) providing a cocoa product blend comprising chocolate liquor and cocoa powder and refining the blend by high pressure and low temperature rolling to an average particle size of about 25 to about 50 microns, which produces a refined crumb blend having 15-30% total fat content by weight; b) mixing water and one or more suitable aeration agents, and mixing in a separate container from the blend; c) adding a sugar to the mixture of b); d) optionally adding vanilla to the mixture of c); e) then finally whipping the mixture of b)-d) into a stable foam matrix, where a stable foam matrix does not lose its shape at room temperature and prior to subsequent baking of deposited forms of the matrix. Then, the refined crumb blend of a) is mixed in the stable foam matrix. Optionally, additional coloring agents, texture, and/or flavor agents can be added. The resulting product is baked into a solid, stable meringue product. In preferred embodiments, the total fat content of the refined crumb blend is between 26-28%, or less than 30%.

The methods can use cocoa products in the refined crumb blend that consist of 50% chocolate liquor by weight and 50% cocoa powder by weight. A sugar can also be added to the blend comprising chocolate liquor and cocoa powder to make the refined crumb blend. One or more of several sugars can be used, and sucrose and inulin are preferred.

The preferred aeration agent is a dairy-based albumin replacer. Any aeration agent can be combined with a stabilizing hydrocolloid (gum Arabic is preferred) in mixing to form the foam matrix. One or more egg white proteins can be used as the aeration agent, and, as noted, in combination with gum Arabic. Similarly, egg white albumin can be used. The methods of the invention can specifically exclude the use of pressurized containers to produce an aerated product, or specifically exclude the use of pressurized gas or CO₂ to produce an aerated product.

The final baked product or ingredient can be a chocolate meringue-type product comprising approximately 15% chocolate liquor, approximately 0.01% moisture, one or more aeration agents, approximately 50% of one or more sugars, and cocoa powder. This final baked product can hold a stable form once it is deposited for baking and substantially retain that form through baking. This is in direct contrast to other, similar products, where the temperature of baking leads to a loss of shape or form. As noted from the methods described above, the baked chocolate can include vanilla, gum Arabic or other suitable hydrocolloid, soluble carbohydrates such as sucrose, or other sugars or combinations of sugars. In addition, ingredients such as sugar alcohols, inulin, or polydextrose can be used in place of sugar to contribute to calorie and sugar reduction. Thus, the invention also includes a baked, aerated chocolate- or cocoa-containing meringue-type product produced by any of the methods described here.

Throughout this disclosure, applicants refer to journal articles, patent documents, published references, web pages, and other sources of information. One skilled in the art can use the entire contents of any of the cited sources of information to make and use aspects of this invention. Each and every cited source of information is specifically incorporated herein by reference in its entirety. Portions of these sources may be included in this document as allowed or required. However, the meaning of any term or phrase specifically defined or explained in this disclosure shall not be modified by the content of any of the sources. The description and examples that follow are merely exemplary of the scope of this invention and content of this disclosure and do not limit the scope of the invention. In fact, one skilled in the art can devise and construct numerous modifications to the examples listed below without departing from the scope of this invention.

### BRIEF DESCRIPTION OF THE DRAWINGS

Preferred aspects, objects, and embodiments of the invention are schematically represented in the exemplary drawings and flow charts, which in no way should be taken as a limitation on the scope or extent of the invention.

FIG. 1 depicts a flow diagram showing an exemplary method for producing an aerated baked food product of the invention

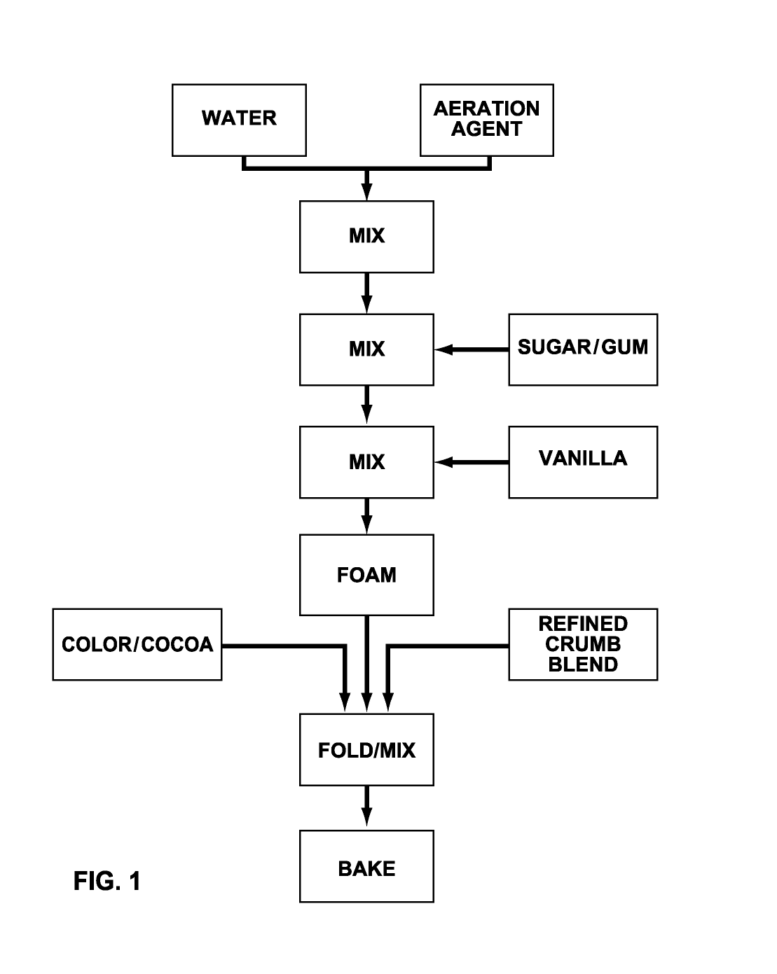

FIG. 2 shows a graph of the antioxidant levels of baked as compared to pre-baked samples as measured by Folin-Ciocalteu assay of total polyphenols (TPP Values) known in the art. Samples A and B are prepared with alkalized cocoa powder in the refined crumb, resulting in lower TPP levels. Sample C contains natural cocoa powder that has not been alkali treated. In all samples, the levels of TPP remain similar in pre- and post-bale samples.

FIG. 3 shows a graph of the antioxidant levels similar to those shown for the same Samples A, B, and C of FIG. 2, but the assay for antioxidants is the Oxygen radical absorbance capacity (ORAC) assay known in the art.

### DETAILED DESCRIPTION OF EXEMPLARY EMBODIMENTS

In one aspect the invention encompasses a method that incorporates a fat-containing blend of ingredients that has been refined to a specific particle size (about 20-55 micron average particle size) and fat content (15-30% by weight). Specifically, the fat-containing component is mixed with non-fat or low-fat solids ingredients, such as sugar, inulin, cocoa powder, or similar products, or other products consistent with a baking step, and then refined to produce a fine powder that can be slowly added to a whipped, aerated foam matrix. The methods do not require pressurization, vacuum treatment, pressurized gas, or other complicated equipment and thus, the method can specifically exclude each of or any one of a pressurizing step, a vacuum step, and a pressurized gas introduction step. The fat content of the pre-refined mixture or blend should range between 15-30% and is optimally between about 26% and about 28% fat. Lower fat levels of this range are used (fore example 12% to about 15%), however, if the final product composition is a low fat product (from about 12% to about 16%).

Refining parameters, such as gap and roll temperatures, can be manipulated to optimize the refined component. For example, a roll pressure of above 15 psi, or approximately 18 psi, can be used, and a roll temperature of below 20 degrees C., or about 18 degrees C., can be used with these pressures. These are higher pressures and lower temperatures than for typical refining of chocolate. The resulting refined blend can comprise between 30-50% of the final product, which can be a stable, baked aerated product.

In addition and in another aspect, the invention employs an improved foam layer that allows a more stable matrix, a matrix that accepts the refined fat-containing materials without collapsing. Specifically, and in one example, the egg white foaming agent (or aeration agent) has been replaced with a more stable substitute composed of gum arabic and a dairy protein. Other combinations of hydrocolloid and protein ingredients may be also be used as an egg white substitute. A preferred example is the Hyfoama product (Kerry, Beloit, Wis.) and similar dairy-based or vegetable-based replacers of egg albumin. These ingredients can be resistant to heat and more stable to whipping procedures. Gum arabic, such as Instant Gum AA (Colloides Naturels International) can be used as a hydrocolloid, among others available.

In a general example of the method to produce a baked, chocolate meringue-type product with a final fat content ranging from 7.5% to 16%, or more particularly between about 12% and about 16%, the non-fat components can first be batched by blending water, foaming protein (hydrolyzed whey dairy protein or alternative), and part of the sugar used. Separately, the remaining sugar is dry blended with a stabilizer. The foam and stabilizer blends are mixed, flavor is optionally added, followed by slow addition of the refined “fat-blend” (or crumb blend) so that aeration is preserved and maximized. This mixture is deposited on a bakery tray or similar flat surface and baked. Baking conditions can be 225 F for 120 minutes. The product is then cooled and stored in air-tight containers or packaging.

Piece and shape integrity can be maintained and the fat-based ingredients are incorporated into the final product without product collapse when these general parameters are followed. This process allows for a better tasting baked meringue product that mostly contains standard chocolate ingredients, and thus the potential for labeling as a modified chocolate under section 130.10 of the FDA regulations for standard chocolate, or other accepted standards for defining a chocolate product. Flavor variations can also be incorporated to help build uniqueness into the products. For instance, nuts and nut pastes, coconut, dark chocolate, fruit, peppermint, and other components used with chocolate can be incorporated into the product, with a special advantage for fat-based ingredients that would normally need to be excluded due to de-aeration issues.

While the foam or aeration agents noted above are preferred, other egg white (egg albumen) containing agents can be used as the foaming matrix. The main constituent proteins in egg whites are ovalbumin, conalbumin and ovomucoid. The effectiveness of egg white as a foaming agent in meringues arises from the constituent proteins and the glycoproteins present. Egg white is effective in forming a stable foam as opposed to a temporary foam, which is by its nature prone to collapse.

An acceptable and stable foam can be made with just ovalbumin, although the texture of the final product can be effected. The glycoprotein ovomucoid generally adds a higher viscosity than with egg albumen, which can improve foam stability. Ovomucoid is extremely stable to heat. Combinations with other proteins or enzymes are also possible, but using lysozyme with other egg-white proteins, especially ovomucin, can lead to a reduction in foaming capacity. Once formed the foams of these combinations of egg proteins with other proteins or enzymes can have increased strength and stability. However, lysozyme alone is a poor foaming agent.

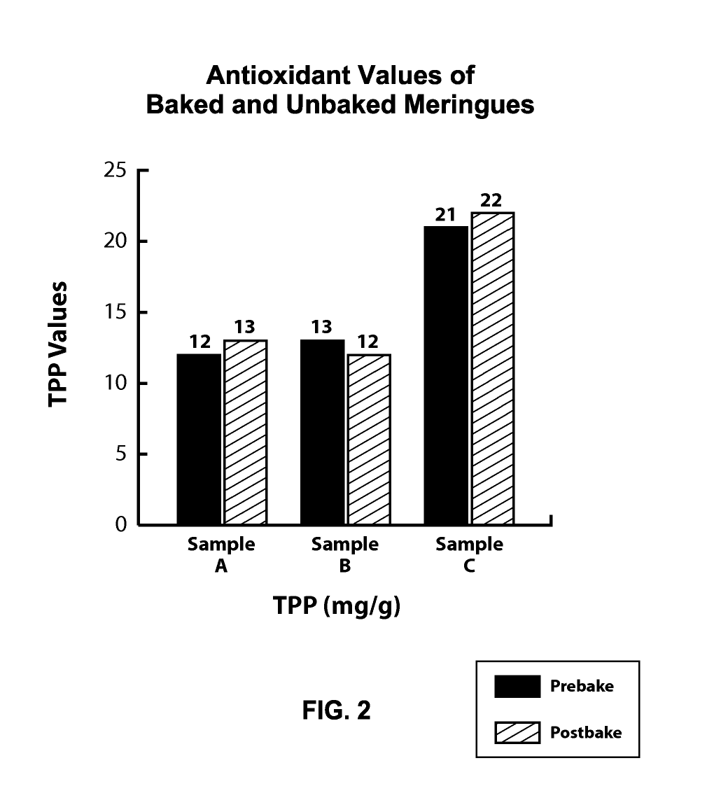

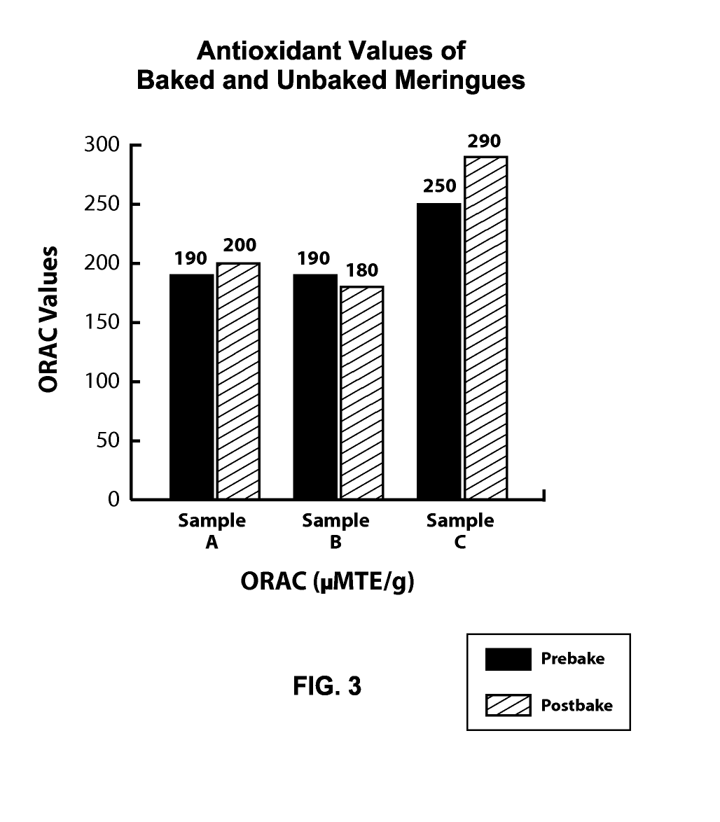

Along with egg components, the two other ingredients usually included in traditional recipes for meringue cakes are sugar and lemon juice. Sugar is added slowly with continued beating, but only after the egg white has first been beaten into a foam. Fine grain sugar should be used in preference to ordinary granulated sugar, since the crystals of the latter are too large to dissolve properly in the aqueous phase of the walls surrounding the air bubbles. The lemon juice reduces the pH towards the isoelectric points of the acidic egg-white proteins and can enhance the surface properties of the foam and its stability. Surface properties of egg component-based foams are increased at the isoelectric point of the proteins. However, in one aspect of the current invention it is desirable to maintain neutral to basic pH in the product to preserve flavanol compounds and resulting ORAC values. ORAC content in cocoa, and especially high ORAC from cocoa antioxidant compounds and epicatechin, has been shown to exhibit favorable effects on blood pressure and blood circulation in favor of heart healthy nutrition. Other health effects have clinically been demonstrated, such as improved mental acuity and energy as a result of high cocoa flavanol content demonstrating high ORAC values. For this reason, gum arabic or another suitable foam stabilizing agent is used as an alternative to lowering pH of the food product. In this way pH is kept neutral to basic. Baked meringue products made with natural or dutched cocoa products as instructed in the current invention result in full preservation of ORAC values in post versus pre-baked products (see FIG. 2-3, where Sample C contains natural cocoa powder, and Samples A and B contain dutched or alkalized cocoa powder). While the use of acids, bases or other pH adjusting agents (food approved acids, bases, or buffering compositions) is not required, they can optionally be included in the invention, especially if preserving or maintaining flavanol content or antioxidant capacity is required or desired. One of skill in the art is familiar with various acid, base, and buffering or pH adjusting compounds or compositions for this purpose.

Whole egg based compositions can also be used. Non-fat milk solids, starches and food gums can be added to improve the foams made from whole-egg compositions.

Accordingly, a number of foam agents or aeration agents can be used to product a foam matrix of the invention, as well as various combinations of these agents, but the preferred embodiment employs the Hyfoama product. Consistent with the composition of Hyfoama, other combinations of hydrocolloid and at least one dairy protein ingredient may also be used.

As noted above, the present invention utilizes a standard baked meringue cookie procedure that incorporates a fat-containing blend of ingredients that has been refined to a specific particle size (20-55 micron average) and fat content (15-30%). A smaller average particular size is used for higher levels of fat in the final product. Numerous specific averages and variations within the range of 20-55 microns can be selected and used. Similarly, numerous specific fat content levels and variations within the range 15-30% total fat content can be selected and used for the pre-mixed blend of fat-containing ingredients.

In specific examples of the methods to produce aerated chocolate products, the fat-containing component is mixed with non-fat or low-fat solids ingredients (sugar, inulin, cocoa powder, etc.) and refined to produce a fine powder. This fine powder can be slowly added to a whipped, aerated foam matrix. The total fat content of the pre-refined powder mixture should range between 15-30% and is optimal at 26-28% fat. Lower levels of this broader range are used, however, if the final product composition should be lower in fat. The resulting refined portion comprises between 30-50% of the final product.

A chocolate meringue cookie-type product, using levels of chocolate liquor of up to 15% of the product, can be made according to the invention. The use of chocolate liquor provides a distinct taste advantage over processes employing only cocoa powder. The ability to produce a unique refining procedure that results in a powdered chocolate liquor led to successful aeration of the meringue cookie product, and that product maintains its shape during deposition and baking steps in manufacturing. The addition of a powder blend, and not the free flowing chocolate liquor, also allowed air incorporation at standard pressures to form small stable bubbles and these bubbles do not collapse. In prior methods using chocolate liquor, the free fat available in the free flowing liquor collapsed the air bubbles over time, leading to a flawed product with poor appearance qualities and an inconsistent shape and texture.

Specific Example—Product aerated very well and held shape completely during baking step. Crumb blend in this example is made from 50% chocolate liquor (Barry-Callebaut, Zurich, Switzerland) and 50% cocoa powder, which is then refined to 17-20 micron average particle size using a refining approach with roller pressures set to 18 psi and temperatures set to 18 degrees C.

Water (preferably cold water) and an aeration agent (Hyfoama®) are mixed in a bowl. In a separate container, sugar and Instant Gum AA (Colloides Naturels) are blended. Optional flavors can be added.

In separate containers weigh and combine refined crumb blend (composed of 50% chocolate liquor and various levels of sugar and cocoa powder depending on specific formula). The water and aeration agent are whipped in a Hobart bowl with wire whip attachment on lowest speed for 1 minute to fully disperse aeration agent. Mix on slightly higher speed for 30 seconds. Begin slowly adding sugar/gum mixture at 30 seconds and mix for additional 2 minutes. Mix on higher speed for 30 seconds. Add vanilla extract or other flavors if desired. Mix on higher speed for 30 additional seconds. A desired amount of this foam matrix can be optionally mixed with dry cocoa powder (about 2.5%) for color. The result is a stable foam matrix that can be mixed with a chocolate liquor containing blend, or other fat-containing blend.

The refined crumb blend is then gently mixed into the stable foam matrix. The resulting mixture can be deposited into desired shapes and then baked for 120 minutes at 225° F.

TABLE 1

| | Wt % | grams/batch |
|---|---|---|
| Water | | 100 |
| Hyfoama | 12.20 | 18.1 |
| Instant Gum AA | 2.21 | 6.7 |
| Sucrose | 0.82 | 469 |
| liquor/cocoa | 57.20 | 220 |
| refined blend | 26.83 | 6.2 |
| Vanilla Extract | 0.76 | |
| | 100% | 820 |

Table 1 above shows the ingredients used in an exemplary process as described above. This recipe yields a post-baked percentage of 30.56% for the refined cocoa/liquor blend, which is equivalent to approximately 15% chocolate liquor in the final chocolate meringue product. A final product of 40 g total weight will comprise 0.530 grams moisture, 2.559 grams protein, 4.043 grams fat, and 28.215 grams carbohydrate., and 8.8 grams cocoa. The refined flake or crumb is 50% liquor and 50 cocoa powder. The samples shown in the Figures are produced from the above example, where for some samples alkalized cocoa powder is used exclusively as the cocoa powder (Sample A and B), or natural (non-alkali treated) cocoa powder is used exclusively as the cocoa powder (Sample C), or vanillin is optionally added (Sample B).

In contrast to the stable chocolate meringue product produced from the process above, prior art methods using chocolate as a base failed to produce a meringue product stable to baking in the oven. The prior art method involved combining cold water, egg white powder, and cream of tartar in a mixing bowl. Separately, sugar and Fibregum B are mixed. In a bench-top mixer on low speed, mix the water/egg white for 1 minute. Increase to medium speed, mix for 0.5 minutes and begin to add sugar mixture, and mix for an additional 1 minute. Increase to high speed, mix for 0.5 minutes, add vanilla extract, mix for an additional 0.5 minutes. Reduce to medium speed, add cocoa powder, mix for 20 secs, scrape bowl, and mix for an additional 20 secs. Add melted milk chocolate and gently fold in until uniform in color. This composition is deposited as 2-3 cm circles on a parchment-lined baking sheet and baked at 225° F. for 120 min. The resulting product fails to hold its shape and texture. Attempts with 25% milk chocolate, 50% milk chocolate, and 70% milk chocolate similarly fail to hold shape and texture. These same mixing conditions and baking conditions can be used for the methods and compositions of the invention.

The examples presented above and the contents of the application define and describe examples of the many cocoa compositions, products, and methods that can be produced or used according to the invention. None of the examples and no part of the description should be taken as a limitation on the scope of the invention as a whole or of the meaning of the following claims.

What is claimed is:

1. A method of producing a baked, aerated food product, comprising:
a) providing a blend comprising chocolate liquor and cocoa powder and refining by high pressure, low temperature rolling to an average particle size of about 25 to about 50 microns to produce a refined crumb blend having 15-30% total fat content by weight;
b) mixing water and one or more suitable aeration agents separate from the blend of a);
c) adding a sugar mixture to the mixture of b);
d) optionally adding vanilla to the mixture of c);
e) whipping the mixture of d) into a stable foam matrix;
f) adding the refined crumb blend of a) into the foam matrix of e) and optionally adding coloring agents and/or flavor agents; and
g) baking into a solid, stable meringue product.

2. The method of claim 1, wherein the cocoa products of the refined crumb blend comprise 50% chocolate liquor and 50% cocoa powder.

3. The method of claim 2, wherein a sugar is added to the blend comprising chocolate liquor and cocoa powder crumb blend.

4. The method of claim 1, wherein one or more of sucrose, inulin, polydextrose their combinations as well as other soluble carbohydrate substitutes is added to the blend of chocolate liquor and cocoa powder.

5. The method of claim 1, wherein a dairy-based albumin replacer is used as the aeration agent and gum arabic is included in the foam matrix.

6. The method of claim 5, wherein the fat content of the refined crumb blend is between 26-28%.

7. The method of claim 1, wherein egg white proteins are used as the aeration agent.

8. The method of claim 1, wherein egg white albumin is used as the aeration agent.

9. A baked chocolate-containing, aerated, food product comprising approximately 15% chocolate liquor, approximately 0.01% moisture, a dairy-based aeration agent, approximately 50% sugar, and cocoa powder, wherein the final baked product holds a stable form once deposited for baking.

10. The baked chocolate-containing, aerated product of claim 9, further comprising vanilla.

11. The baked chocolate-containing, aerated product of claim 9, further comprising gum arabic.

12. The baked chocolate-containing, aerated product of claim 9, wherein the sugar is sucrose.

13. A baked chocolate-containing, aerated product produced by the method of claim 1.

14. A baked chocolate-containing, aerated product produced by the method of claim 3.

15. A baked chocolate-containing, aerated product produced by the method of claim 6.

16. The method of claim 1 that does not include the use of pressurized gas.

17. The method of claim 1 that does not include a pressurize-controlled container.

18. The method of claim 1 further comprising preserving antioxidants by maintaining a neutral to basic pH.

19. The method of claim 2 further comprising preserving antioxidants by maintaining a neutral to basic pH.

20. The method of claim 18, wherein epicatechin levels are maintained.

21. The method of claim 19, wherein epicatechin levels are maintained.

22. The food product of claim 9, further comprising one or more food approved base or buffering compositions to maintain a neutral to basic pH.
